(19) United States
(12) Patent Application Publication
(10) Pub. No.: US 2015/0281385 A1
(43) Pub. Date: Oct. 1, 2015

(54) LOCATION CONTENT PROVIDING SERVER, LOCATION CONTENT PROVIDING METHOD, LOCATION CONTENT PROVIDING SERVER PROGRAM

(71) Applicant: OPTiM Corporation, Saga-shi (JP)

(72) Inventor: Shunji SUGAYA, Tokyo (JP)

(21) Appl. No.: 14/452,689

(22) Filed: Aug. 6, 2014

(30) Foreign Application Priority Data
Mar. 26, 2014 (JP) 2014-063683

(51) Int. Cl. H04L 29/08; G06F 17/30

(52) U.S. Cl. CPC H04L 67/22; G06F 17/30241

(57) ABSTRACT

A location information based content is provided to a mobile terminal. A location content providing server 200 is communicatively connected to a mobile terminal 10, and includes a storage unit having a content location database 250 in which location information and URLs of web resources are associated with each other and are stored. The location content providing server 200 identifies a location of the mobile terminal 10 by receiving current location information from the mobile terminal 10, extracts from the content location database a URL that is associated with location information within a predetermined range based on the identified location, and provides the mobile terminal 10 with the extracted URL.

### CROSS-REFERENCE TO RELATED APPLICATION

The present application claims priority to and the benefit of Japanese Patent Application No. 2014-063683 filed on Mar. 26, 2014, the entire contents of which are incorporated herein by reference.

### BACKGROUND

(a) Field

The present invention generally relates to a location content providing server, location content providing method, location content providing server program for providing a location information based content.

(b) Description of the Related Art

In recent years, with spread of high-performance mobile terminals called smartphones or tablets, it is explosively increased to use contents as users move. Further, contents that users expect to browse in many places are increasing.

On the other hand, many of users are currently browsing web contents using search engines, and so-called pull-type content provision in which the users see what they want to see becomes the mainstream. However, in this case, a problem that precious contents do not provided to the users occurs.

To solve this problem, a recommendation system has been developed. The recommendation system performs a recommendation using the user's attributes without performing pre-registration for the user by using acquired face image of the user.

For example, Japanese Patent Publication No. 2013-073420 discloses that a mobile terminal acquires a user's face image and extracts a feature quantity from the acquired user's face image. Then, the mobile terminal transmits the extracted feature quantity to a recommendation server. The recommendation server receives the feature quantity from the mobile terminal, stores at least a plurality of feature quantities, performs matching processing of the received feature quantity with the stored feature quantities, recommends an application or the like on the basis of the matching result, and transmits the recommendation result to the mobile terminal. The mobile terminal receives the recommendation result from the recommendation server, and displays the received recommendation result.

However, since the recommendation is performed based on individual information such as the face in the above reference, it is impossible to perform the recommendation based on environment information such as location or time zone.

### SUMMARY

An aspect of the present invention is directed to provide a location content providing server, a location content providing method, and a location content providing server program for identifying a current location of a user from usage information of a GPS (Global Positioning System) or a public wireless LAN (Local Area Network) and then providing the user with a URL (Uniform Resource Locator) of a content that is associated with the identified location, thereby providing the user with the content according to the location information.

The present invention may provide the following aspects.

In a first aspect of the present invention, a location content providing server communicatively connected to a mobile terminal is provided. The location content providing server includes a storage unit having a content location database in which location information and URLs of web resources are associated with each other and are stored, a location information identification module configured to identify a location of the mobile terminal by receiving current location information from the mobile terminal, a content extraction module configured to extract from the content location database a URL that is associated with location information within a predetermined range based on the identified location, and a location content providing module configured to provide the mobile terminal with the extracted URL.

According to the first aspect of the present invention, a location content providing server communicatively connected to a mobile terminal includes a storage unit having a content location database in which location information and URLs of web resources are associated with each other and are stored, and can identify a location of the mobile terminal by receiving current location information from the mobile terminal, extract from the content location database a URL that is associated with location information within a predetermined range based on the identified location, and provide the mobile terminal with the extracted URL.

The first aspect of the present invention relates to the location content providing server, but may be applicable to a location content providing method and a program for a location content providing server in the same manner.

In a second aspect of the present invention, the location content providing server further including an IP (Internet Protocol) address reception module configured to receive from the mobile terminal an SSID (Service Set IDentifier) or IP address of an access point that is used by the mobile terminal is provided. The location information identification module identifies the location of the mobile terminal by using the received SSID or IP address when identifying the location of the mobile terminal.

According to the second aspect of the present invention, the location content providing server according to the first aspect can receive from the mobile terminal an SSID or IP address of an access point that is used by the mobile terminal, and identify the location of the mobile terminal by using the received SSID or IP address when identifying the location of the mobile terminal.

In a third aspect of the present invention, the location content providing server further including a domain reception module configured to receive a domain from the mobile terminal is provided. In this case, a location based content is provided by transmitting the extracted URL as a URL indicated by the received domain.

According to the third aspect of the present invention, the location content providing server according to the first aspect or the second aspect can receive a domain from the mobile terminal is provided, and a location based content can be provided by transmitting the extracted URL as a URL indicated by the received domain.

In a fourth aspect of the present invention, the location content providing server in which the location based content is provided by redirecting an access of the mobile terminal to the extracted URL is provided.

According to the fourth aspect of the present invention, in the location content providing server according to any one of the first aspect, the second aspect and the third aspect, the location based content can be provided by redirecting an access of the mobile terminal to the extracted URL is provided.

In a fifth aspect of the present invention, a location content providing method executed by a location content providing server is provided, and the location content providing server is communicatively connected to a mobile terminal and includes a storage unit including a content location database in which location information and URLs of web resources are associated with each other and are stored. The location content providing method includes receiving from the mobile terminal an IP address of a access point that is used by the mobile terminal, identifying a current location of the mobile terminal by using the received IP address, extracting from the content location database a URL that is associated with location information within a predetermined range based on the current location, and providing the mobile terminal with the extracted URL.

In a sixth aspect of the present invention, a program for executing a location content providing method on a location content providing server or a recording medium storing the program is provided. The location content providing server is communicatively connected to a mobile terminal and includes a storage unit including a content location database in which location information and URLs of web resources are associated with each other and are stored. The location content providing method includes receiving from the mobile terminal an IP address of a access point that is used by the mobile terminal, identifying a current location of the mobile terminal by using the received IP address, extracting from the content location database a URL that is associated with location information within a predetermined range based on the current location, and providing the mobile terminal with the extracted URL.

Aspects of the present invention can provide a location content providing server, a location content providing method, and a location content providing server program for identifying a current location of a user from usage information of a GPS or a public wireless LAN and then providing the user with a URL of a content that is associated with the identified location, thereby providing the user with the content according to the location information.

### BRIEF DESCRIPTION OF THE DRAWINGS

FIG. 1 is a diagram for explaining an overview of a location content providing system 1 according to an embodiment of the present invention.

FIG. 2 is a system block diagram of a location content providing system 1 according to an embodiment of the present invention.

FIG. 3 is a function block diagram of a mobile terminal 10, a location content providing server 200, and a web server 300.

FIG. 4 is a flowchart of a location content providing process executed by a mobile terminal 10, a location content providing server 200, and a web server 300.

FIG. 5 is a schematic diagram showing an overview of a case that a location content providing server 200 acts as a DNS.

FIG. 6 shows an example of a display unit of a mobile terminal 10 displaying a received content.

FIG. 7 shows an example of a content location table in a content location database 250 when a location content providing server 200 acts as a DNS.

FIG. 8 shows an example of a content location table in a content location database 250 when a location content providing server 200 acts as a web server.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Overview of Location Content Providing System 1

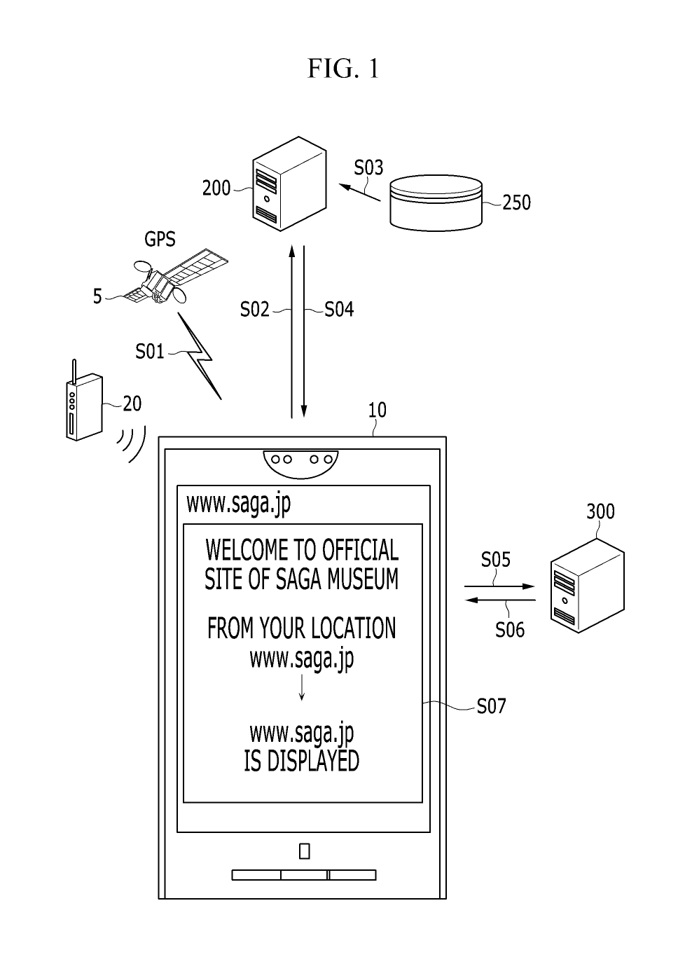

FIG. 1 is a diagram for explaining an overview of a location content providing system 1 according to an embodiment of the present invention. The location content providing system 1 includes a mobile terminal 10, a location content providing server 200, and a web server 300.

In the position content providing system 1, the mobile terminal 10 identifies a current location of the mobile terminal 10 by using latitude and longitude information acquired by GPS (Global Positioning System) system 5, connection information to a public wireless LAN (Location Area Network) connection point 20, and communication information with a base station (Step S01). Then, the mobile terminal 10 sends location information indicating the identified location to the location content providing server 200 (Step S02).

The location content providing server 200 that has received the location information extracts from a content location database 250 URL(s) (Uniform Resource Locator) of content(s) associated with location information that is within a predetermined range from the received location information (Step S03). In general, the predetermined range may be a circular area whose radius is less than a predetermined length. Alternatively, the predetermined range may be a rectangular area or the other shape area.

The location content providing server 200 transmits the extracted URL to the mobile terminal 10 (Step S04). When a plurality of URLs have been extracted, the location content providing server 200 may select a URL that is nearest to the location information from among the plurality of URLs. Alternatively, the location content providing server 200 may select a URL having the largest weight from among the plurality of URLs referring to weights predefined for the URLs.

On receiving the URL, the mobile terminal 10 transmits a request to the web server 300 based on the URL (Step S05). The web server 300 transmits to the mobile terminal 10 a web page, image(s), or videos(s) in response to the request (Step S06). A web browser or a video player software running in the mobile terminal 10 plays the received data, thereby playing the content on the mobile terminal 10 (Step S07).

Here, as a rule, the location content providing server 200 only provide the URL of the content, but does not provide the content itself. Accordingly, information about a relationship between the location information and contents stored in other servers can be provided as well as contents stored in the location content providing server 200 such that information to be handled can be increased.

The above is the overview of the location content providing system 1.

System Configuration of Location Content Providing System 1

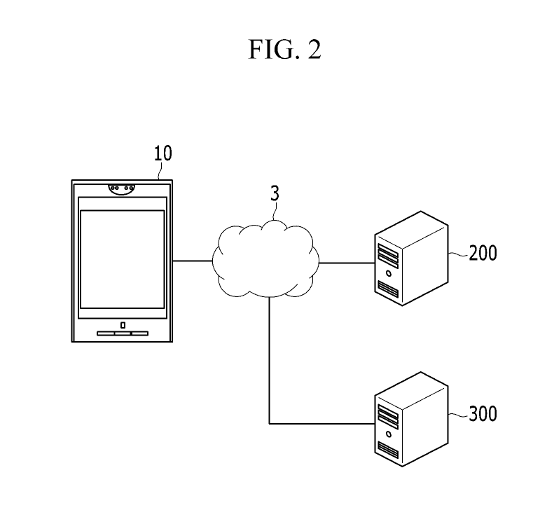

FIG. 2 is a system block diagram of a location content providing system 1 according to an embodiment of the present invention. The location content providing system 1 includes a mobile terminal 10, a location content providing server 200, a web server 300, and a public network 3 (for example, an internet network, or the third generation or fourth generation communication network).

The mobile terminal 10 has functions to be described below, and can perform data communication. The mobile terminal 10 is an electric appliance for home or commercial use that can be used while a user moves with carrying it. For example, the mobile terminal 10 may be a mobile phone, a portable information terminal, or a home information appliance such as a smartphone, a tablet terminal, a netbook terminal, a slate terminal, an electronic dictionary terminal, a portable music player, or the like.

The location content providing server 200 has functions to be described below, and is a server for providing a URL of a content according to location information of the mobile terminal 10.

The web server 300 may be a typical web server for providing a web content to the mobile terminal 10.

Description of each Function

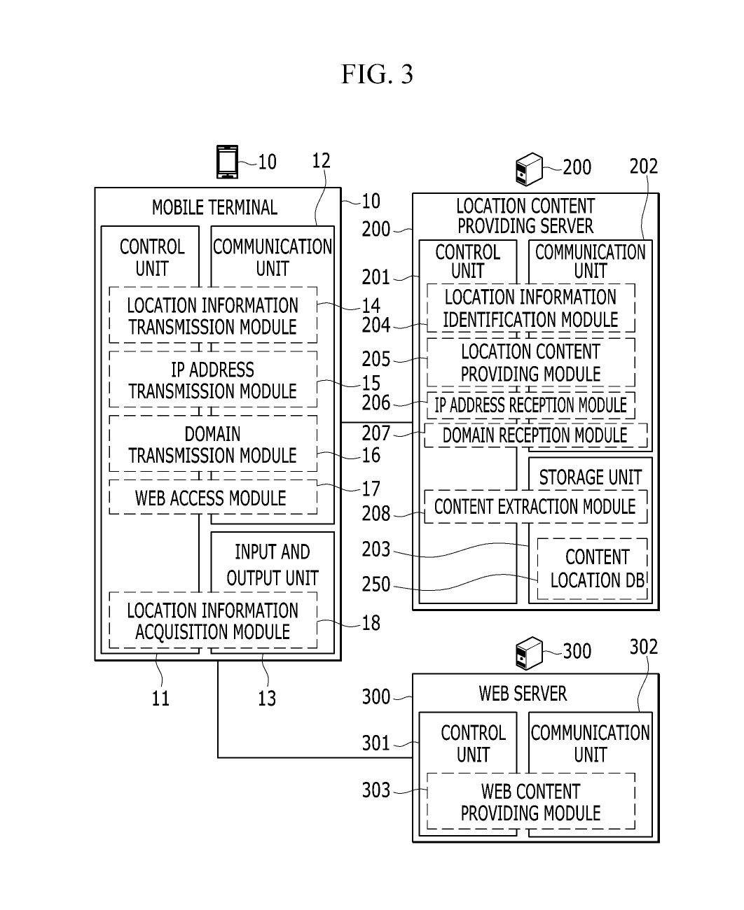

Configuration of each device is described with reference to FIG. 3.

The mobile terminal 10 includes a Central Processing Unit (CPU), a Random Access Memory (RAM), a Read Only Memory (ROM) and the like as a controller 11. The mobile terminal 10 further includes, as a communication unit 12, a device for enabling a communication with other device, for example a WiFi (Wireless Fidelity) enabled device based on IEEE 802.11.

The mobile terminal 10 further includes, as an input and output unit 13, a display unit for displaying data and images controlled by the control unit 11, a touch panel, a keyboard, or a mouse for receiving an input from a user, and a device for acquiring location information such as a GPS.

In the mobile terminal 10, the control unit 11 reads a predetermined program, thereby realizing a location information transmission module 14, an IP address transmission module 15, a domain transmission module 16, and a web access module 17, in cooperation with the communication unit 12. Further, in the mobile terminal 10, the control unit 11 reads a predetermined program, thereby realizing a location information acquisition module 18 in cooperation with the input and output unit 13.

Similarly to the mobile terminal 10, the location content providing server 200 includes a CPU, a RAM, a ROM and the like as a control unit 201. The location content providing server 200 further includes, as a communication unit 202, for example, a WiFi enabled device based on IEEE 802.11, or other appliance such as a device for enabling a connection by a wire cable, and a device for realizing a data communication with a wireless access point. Furthermore, the location content providing server 200 further includes, as a storage unit 203 for storing data and files, a data storage unit according to a hard disk, a semiconductor memory, a recording medium, or a memory card. The storage unit 203 includes a content location database 250.

The wireless access point is a device to which the mobile terminal 10 is connected through the WiFi by using an SSID (Service Set Identifier), and may be a device for enabling a connection to an external internet. One example of an IP (Internet Protocol) address which the wireless access point has is a global IP address. Since the IP address is uniquely determined in the world, the location can be identified according to the IP address of the wireless access point, by associating the IP address with location information in a table or the like in advance

In the location content providing server 200, the control unit 201 reads a predetermined program, thereby realizing a location information identification module 204, a location content providing module 205, an IP address reception module 206, and a domain reception module 207, in cooperation with the communication unit 202. Further, in the location content providing server 200, the control unit 201 reads a predetermined program, thereby realizing a content extraction module 208 in cooperation with the storage unit 203.

Similarly to the mobile terminal 10, the web server 300 includes a CPU, a RAM, a ROM and the like as a control unit 301. The web server 300 further includes, as a communication unit 302, for example, a WiFi enabled device based on IEEE 802.11, or other appliance such as a device for enabling a connection by a wire cable, and a device for realizing a data communication with a wireless access point.

In the web server 300, the control unit 301 reads a predetermined program, thereby realizing a web content providing module 303 in cooperation with the communication unit 302.

Location Content Providing Process

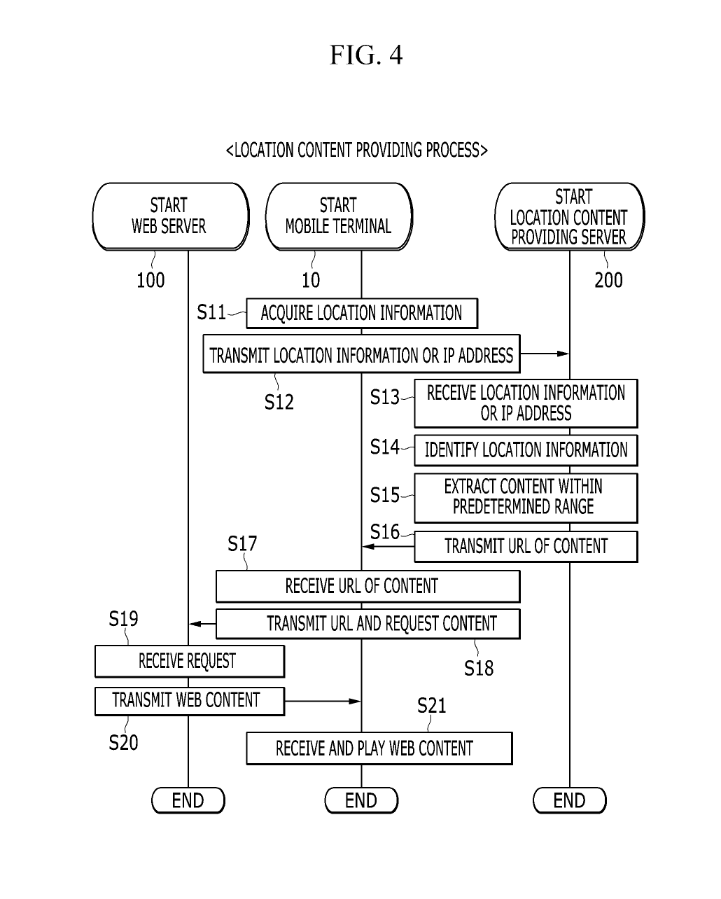

FIG. 4 is a flowchart of a location content providing process executed by a mobile terminal 10, a location content providing server 200, and a web server 300. Processes executed by the modules of each device described above are described in conjunction with the present procedure.

First, the location information acquisition module 18 of the mobile terminal 10 identifies a current location of the mobile terminal 10 and acquires location information by using a location information acquisition device such as a GPS or the like, or connection information of a public wireless LAN (Step S11).

Next, the location information transmission module 14 of the mobile terminal 10 or IP address transmission module 15 transmits the location content providing server 200 location information of the mobile terminal 10, or an SSID (service set identifier) or IP address of the wireless access point to which the mobile terminal 10 is connected (Step S12).

The location information identification module 204 of the location content providing server 200 receives the location information, or the IP address or SSID (Step S13), and identifies a current location of the mobile terminal 10 from the received location information, or the received IP address or SSID (Step S14). Here, in the case of receiving the location information, the location information identification module 204 specifies the received location information as the current location of the mobile terminal 10. In the case of receiving the IP address or SSID, the location information identification module 204 identifies a location of the access point from the IP address or SSID, and specifies the identified location as the current location of the mobile terminal 10.

Subsequently, the content extraction module 208 of the location content providing server 200 extracts from the content location database 250 a URL of a content that is within a predetermined range from the identified location information (Step S15).

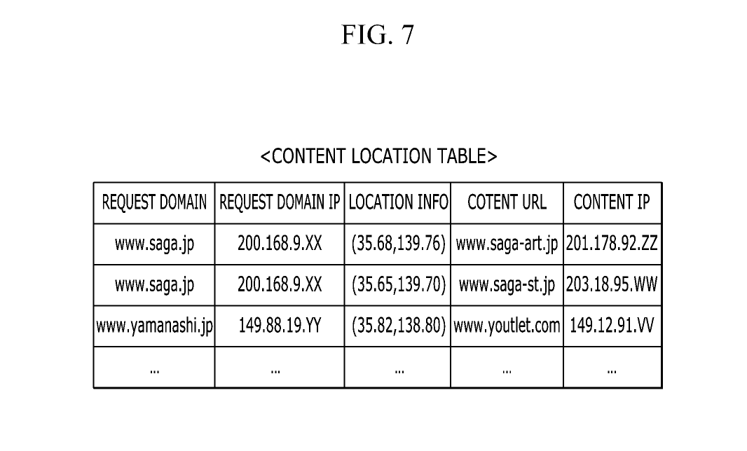

FIG. 7 shows an example of a content location table in a content location database 250 when a location content providing server 200 acts as a DNS (Domain Name System). In the content location table, URLs of contents and location information of the contents are associated with each other and are stored. Further, since a request domain is associated with each of the contents in the content location table, it is possible to distinguish and output information by a combination of a specific domain and the location information.

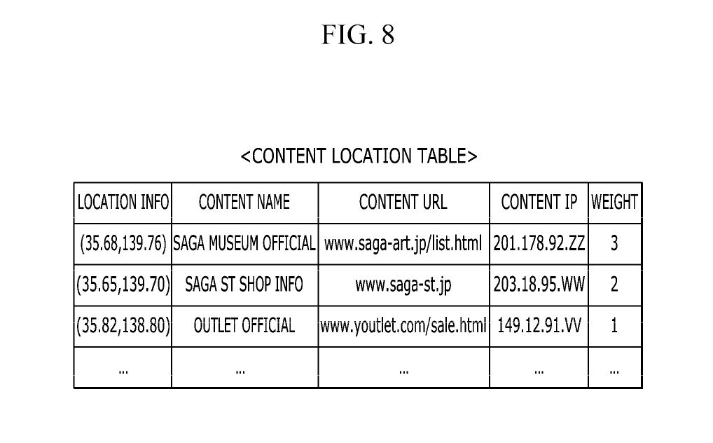

On the other hand, FIG. 8 shows an example of a content location table in a content location database 250 when a location content providing server 200 acts as a web server. Similarly to the case of the DNS, URLs of contents and location information of the contents are associated with each other and are stored in the content location table. However, differently from the case of the DNS, the domain is not associated with the contents in the content location table. This is because a request is not sent to the location content providing server 200 as long as a domain indicating the location content providing server 200 is not specified, differently from the case of the DNS. Therefore, even if the domain is set, it is limited to a domain that is accessible to the location content providing server 200.

Here, a weight may be assigned to each of contents in the content location table. When there are a plurality of contents within the predetermined range, any one of the contents may be selected referring to the weight. The weight may be set in the same manner regardless of whether the location content providing server 200 acts as the DNS or acts as the web server. The location content providing module 205 of the location content providing server 200 transmits the extracted URL of the content to the mobile terminal 10 (Step S16).

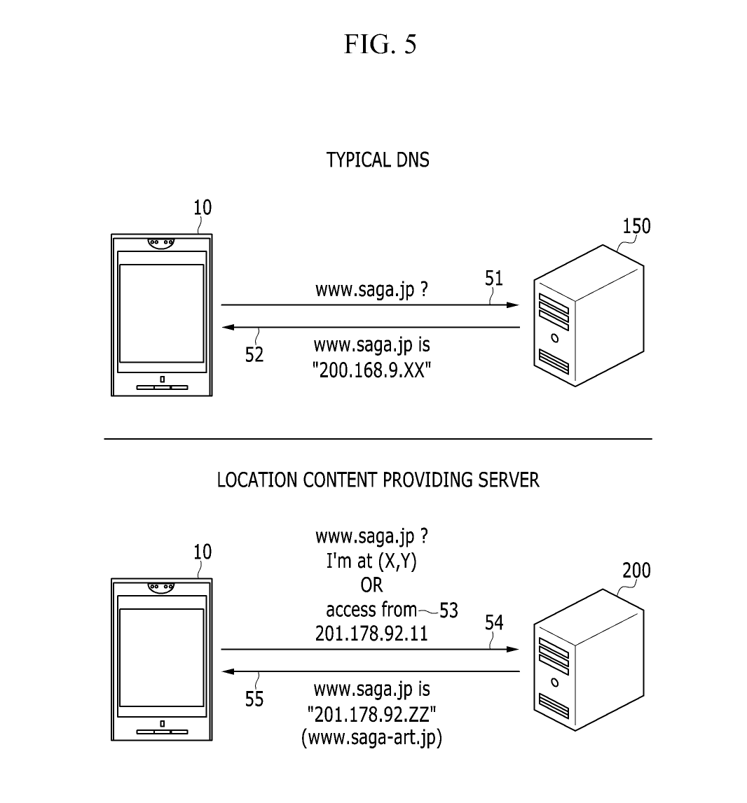

FIG. 5 is a schematic diagram showing an overview of a case that a location content providing server 200 acts as a DNS. In communicating with a typical DNS server 150, if the mobile terminal 10 queries a domain of “www.saga.jp” as a request 51, the DNS server 150 refers to A record of the domain and transmits an IP address of “200.168.9.XX” indicated by the domain as a response.

On the other hand, in the case that the location content providing server 200 acts as a DNS, a request 53 transmitted by the mobile terminal 10 includes location information, or an SSID or IP address of the access point as well as a domain of “www.saga.jp.” The location content providing server 200 send a URL which is extracted by the process described above. as a response 54.

On receiving the URL of the content (Step S17), the web access module 17 of the mobile terminal 10 transmits a request for the content to the web server 300 designated as an access destination by the URL (Step S18).

Similarly to the typical web browsing, when receiving a request (Step S19), the web content providing module 303 of the web server 300 transmits a web page, an image, a video, or streaming corresponding to the request as a response (Step S20). The web access module 17 or the mobile terminal 10 receives the web page, the image, the video, or the streaming, and plays the same as the content (Step S21).

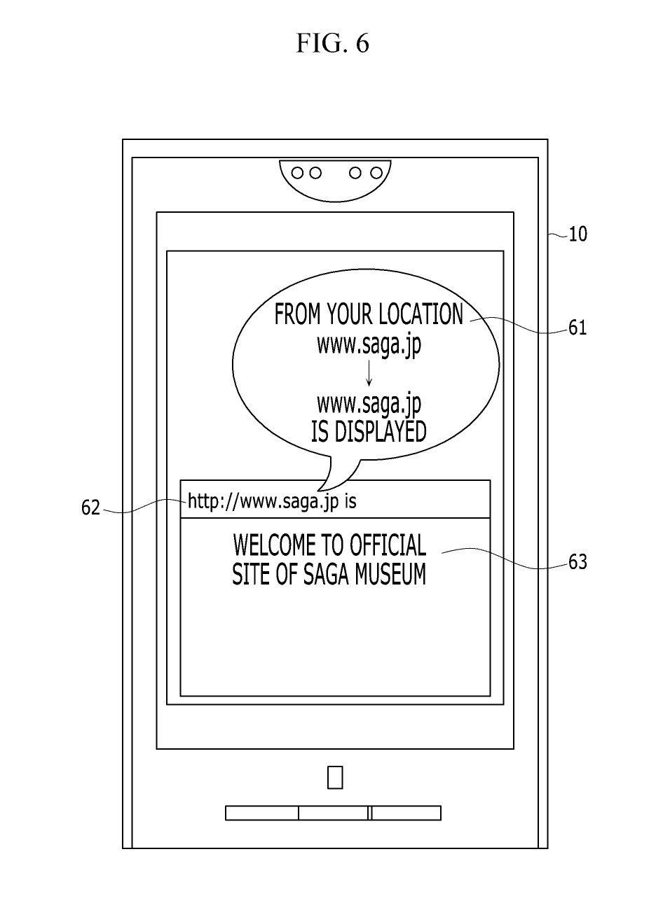

FIG. 6 shows an example of a display unit of a mobile terminal 10 displaying a received content. In FIG. 6, a detail indicating that a domain requested by the user has been converted into a domain of a content is displayed as a pop-up 61, and a web content 63 is displayed. A domain displayed in an address bar may be a URL that has not been converted or may be a URL of the content.

The above is the procedure of a location content providing process executed by the mobile terminal 10, the location content providing server 200, and the web server 300.

The above-described means and functions are realized by reading and executing a predetermined program by a computer (including a CPU, an information processing apparatus, and various terminals). The program is recorded in a (non-transitory) computer-readable recording medium, for example, a flexible disk, a CD (e.g., a CD-ROM or the like) and a DVD (e.g., a DVD-ROM, a DVD-RAM, or the like). In this case, the program is read from the recording medium by a computer and transmitted to an internal storage unit or an external storage unit to be stored and executed. Further, the program may be pre-stored in a storage unit (recording medium) such as a magnetic disk, an optical disk, or an optical magnetic disk and transmitted from the recording medium to a computer through a communications line.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A location content providing server communicatively connected to a mobile terminal, the location content providing server comprising:
a storage unit including a content location database in which location information and URLs (Uniform Resource Locators) of web resources are associated with each other and are stored;
a location information identification module configured to identify a location of the mobile terminal by receiving current location information from the mobile terminal;
a content extraction module configured to extract from the content location database a URL that is associated with location information within a predetermined range based on the identified location; and
a location content providing module configured to provide the mobile terminal with the extracted URL.

2. The location content providing server of claim 1, further comprising an IP (Internet Protocol) address reception module configured to receive from the mobile terminal an SSID (Service Set Identifier) or IP address of an access point that is used by the mobile terminal,
wherein the location information identification module identifies the location of the mobile terminal by using the received SSID or IP address when identifying the location of the mobile terminal.

3. The location content providing server of claim 2, further comprising a domain reception module configured to receive a domain from the mobile terminal,
wherein a location based content is provided by transmitting the extracted URL as a URL indicated by the received domain.

4. The location content providing server of claim 3, wherein the location based content is provided by redirecting an access of the mobile terminal to the extracted URL.

5. The location content providing server of claim 2, wherein a location based content is provided by redirecting an access of the mobile terminal to the extracted URL.

6. The location content providing server of claim 1, further comprising a domain reception module configured to receive a domain from the mobile terminal,
wherein a location based content is provided by transmitting the extracted URL as a URL indicated by the received domain.

7. The location content providing server of claim 1, wherein a location based content is provided by redirecting an access of the mobile terminal to the extracted URL.

8. A location content providing method executed by a location content providing server that is communicatively connected to a mobile terminal and includes a storage unit including a content location database in which location information and URLs (Uniform Resource Locators) of web resources are associated with each other and are stored, the location content providing method comprising:
receiving from the mobile terminal an IP address of a access point that is used by the mobile terminal;
identifying a current location of the mobile terminal by using the received IP address;
extracting from the content location database a URL that is associated with location information within a predetermined range based on the current location; and
providing the mobile terminal with the extracted URL.

9. The location content providing method of claim 8, further comprising receiving a domain from the mobile terminal,
wherein a location based content is provided by transmitting the extracted URL as a URL indicated by the received domain.

10. The location content providing method of claim 8, wherein the location based content is provided by redirecting an access of the mobile terminal to the extracted URL.

11. A recording medium that stores a program for executing a location content providing method on a location content providing server that is communicatively connected to a mobile terminal and includes a storage unit including a content location database in which location information and URLs (Uniform Resource Locators) of web resources are associated with each other and are stored, the location content providing method comprising:
receiving from the mobile terminal an IP address of a access point that is used by the mobile terminal;
identifying a current location of the mobile terminal by using the received IP address
extracting from the content location database a URL that is associated with location information within a predetermined range based on the current location; and
providing the mobile terminal with the extracted URL.

12. The recording medium of claim 11, wherein the location content providing method further comprises receiving a domain from the mobile terminal, and wherein a location based content is provided by transmitting the extracted URL as a URL indicated by the received domain.

13. The recording medium of claim 11, wherein the location based content is provided by redirecting an access of the mobile terminal to the extracted URL.
